(19) United States
(12) Patent Application Publication
(10) Pub. No.: US 2009/0161912 A1
(43) Pub. Date: Jun. 25, 2009

(54) METHOD FOR OBJECT DETECTION

(76) Inventors: RAVIV YATOM, Tivon (IL); Eirad Heller, Gin Humifratz (IL); Eytan Suchard, K. Bialik (IL)

Correspondence Address: MICHAEL RIES, 318 PARKER PLACE, OSWEGO, IL, 60543, US

(21) Appl. No.: 12/339,073

(22) Filed: Dec. 19, 2008

Related U.S. Application Data
(60) Provisional application No. 61/016,162, filed on Dec. 21, 2007.

(51) Int. Cl. G06K 9/00; G06K 9/62

(52) U.S. Cl. 382/103; 382/159

(57) ABSTRACT

In one aspect, the present invention is directed to a method for object detection, the method comprising the steps of: dividing a digital image into a plurality of sub-windows of substantially the same dimensions; processing the image of each of the sub-windows by a cascade of homogeneous classifiers (each of the homogenous classifiers produces a CRV, which is a value relative to the likelihood of a sub-window to comprise an image of the object of interest, and wherein each of the classifiers has an increasing accuracy in identifying features associated with the object of interest); and upon classifying by all of the classifiers of the cascade a sub-window as comprising an image of the object of interest, applying a post-classifier on the cascade CRVS, for evaluating the likelihood of the sub-window to comprise an image of the object of interest, wherein the post-classifier differs from the homogenous classifiers.

The present application claims the benefit of U.S. Provisional Application No. 61/016,162, filed on Dec. 21, 2007, and incorporated herein by reference.

### FIELD OF THE INVENTION

The present invention relates to the field of object detection in optical processing devices. More particularly, the invention relates to an improved object detection method, in comparison to the prior art.

### BACKGROUND OF THE INVENTION

The term “Object Detection” refers herein in the art to detection of an object in a digital image, and the location of the object on the digital image. The object may be a human figure, a manufactured piece, and so on.

Object detection does not deal with identifying an object, but rather with detecting whether a digital image comprises a searched object, and the location thereof in the digital image. As such object detection is usually used as pre-processing for a more complicated process, such as detecting whether a digital image comprises a human face and the location thereof, prior to detecting the identity of the person in the image.

The information about the presence of an object in a digital image and the location thereof diminishes tremendously the overall processing effort for detecting the identity of the object in the image.

A digital image is a representation of a two-dimensional image as a finite set of digital values. In a two-dimensional image, the digital values are referred to as pixels. Pixels are the smallest individual element in a two-dimensional image, holding quantized values representing the brightness of a given color at any specific point. In digital image, processing, it is common to employ a representation of gray-level pixels rather than color pixels. Typically, the pixels are stored in computer memory as a raster image or raster map, a two-dimensional array of small integers.

U.S. Pat. No. 7,099,510 to Jones et al. (referred to herein as the '510 patent), incorporated herein by reference, discloses an object detection system for detecting instances of an object in a digital image. Thus, the disclosed system is directed to detect whether an image comprises an instance of an object, and the position of the object in the image.

The '510 patent introduces a method for detecting objects in real-time. The method is characterized by providing a very high detection rate. It is essentially a feature-vector based approach in which a classifier is trained for Haar-like rectangular features selected by AdaBoost algorithm. The test of the image is scanned at different scales and positions using a rectangular window. The regions that pass the classifier are declared as objects.

One of the major features of this method is the extremely rapid computation of these features using the concept of Integral Image, which enables the detection in real-time. Additionally, instead of learning a single classifier and computing all the features for all the scanning windows in the image, a number of classifiers are learned. The classifiers are put together in a series to form a cascade. The cascade of “homogenous” classifiers (in the sense that they all have the same behavior) is marked herein by numeral 10. The classifiers of the cascade are marked herein by numerals 1, 2, and 3. Although in the figures herein only three classifiers are illustrated, it should be noted that this is an example, and the number of classifiers may differ.

FIG. 1 schematically illustrates the data flow in a method for object detection, according to the '510 patent.

The cascade of homogenous classifiers is marked herein by numeral 10. The classifiers of the cascade are marked herein by numerals 1, 2, and 3. Although in the figures herein only three classifiers are illustrated, it should be noted that this is an example, and the number of classifiers may differ.

A sub-window is “eliminated” once one of the classifiers indicates that the sub-window does not comprise an image of the searched object.

Each of the classifiers evaluates the presence of one or more features of the object, thereby indicating the likelihood of presence of an object in the examined sub-window. The cascade of classifiers is applied to each of the sub-windows.

For example, the first classifier 1 eliminates a large number of negative examples. It utilizes a limited number of features to identify a large percentage, such as 50%, of the initial set of sub-windows that are unlikely to have any instances of the object. Numeral 20 denotes the eliminated sub-windows.

A classifier may provide one of two indications: “T” (TRUE) or “F” (FALSE). “F” (FALSE) means that the classifier has indicated the likelihood of an examined sub-window to comprise an instance of a searched object as “poor”, and therefore no further classifying processing should be carried out for this sub-window. “T” (TRUE) means that the likelihood of a sub-window has been indicated as “poor”, and therefore it should be further processed.

Thus, the sub-windows eliminated by classifier 1 are not processed by subsequent classifiers 2 and 3. After the last classifier 3 has been applied, the retained sub-windows are passed on for further processing 30, such as output processing (e.g., highlighting the instances of objects in an output image for viewing by an end-user of the object detection system).

FIG. 2 schematically illustrates the data flow in each classifier in the cascade of FIG. 1.

The classifier in this case is classifier 2 of FIG. 1, but the same processing is carried out by each of the classifiers of the cascade.

The input to the classifier is a digital representation of a sub-window.

In the classifier, the input data is processed, resulting in a value X. The value X is referred to herein as the Classifier's Real Value (CRV).

In the next step, value X (the CRV) is compared with a threshold, and if X is greater than the threshold, the result the classifier returns is TRUE, otherwise the returned value is FALSE

It should be noted that no data transformation is carried out between the classifiers of a cascade. In other words, according to the '510 patent, a classifier does not make use of the CRV of the previous classifiers in the cascade.

Due to the nature of typical implementations of the method of the '510 patent, the efficiency of an object detection system is a function of both the percentage of identifying object(s) in a digital image, and the processing speed.

Thus, even if a certain technology provides a relatively high percentage of object detection, if the processing speed is relatively slow with regard to the use, the technology may not be implemental.

For example, a digital camera may employ an object detection technology for identifying in real time whether an image comprises a face of a human being, and focusing on the face in case the result is positive. This process must be carried out in real time while the user focuses the camera on an object, and as such, the processing speed is crucial. As the power supply of a processing unit is also a function of processing ability, a relatively fast processor may require a relatively high-power consumption. Therefore, the efficiency of the method is essential in order to be carried out in minimum processing ability.

As such, a technology is required which improves the performance of object detection technologies of the prior art.

Other objects and advantages of the invention will become apparent as the description proceeds.

### SUMMARY OF THE INVENTION

The following embodiments and aspects thereof are described and illustrated in conjunction with systems, tools methods, and so forth, which are meant to be merely illustrative, not limiting in scope.

In one aspect, the present invention is directed to a method for object detection of an object of interest in a digital image of an optical processing device, the method comprising the steps of:
dividing the digital image into a plurality of sub-windows of substantially the same dimensions;
processing the image of each of the sub-windows by a cascade of homogeneous classifiers, wherein each of the homogenous classifiers produces a CRV, being a value relative to the likelihood of a sub-window to comprise an image of the object of interest, and wherein each of the classifiers has increased accuracy in identifying features associated with the object of interest; and
upon classifying by all of the classifiers of the cascade a sub-window as comprising an image of the object of interest, applying a post-classifier on the CRVs of the cascade, for evaluating the likelihood of the sub-window to comprise an image of the object of interest, wherein the post-classifier differs from the homogenous classifiers.

According to one embodiment of the invention, the post-classifier is based on a Neural Network.

According to another embodiment of the invention, the post-classier is based on a Support Vector Machines.

In embodiments of the present invention, each of the homogeneous classifiers is based on a Linear Discriminant Analysis, such that the best classification vector is used as the vector to be approximated by a linear combination of features/features vectors used in said cascade of classifiers.

The method may further comprise a training process, for training the post-classifier to identify an object of interest. The training process may be based on a unique cumulative/online LDA method, that updates itself after each new training vector, in contrast to the conventional LDA method.

According to one embodiment of the invention, the object of interest is a human face.

According to one embodiment of the invention, the training process for the Neural Network is a Genetic Algorithm. The Genetic Algorithm may use “Selection” operators selected from a group comprising: Positive reward and Negative reward, thereby overcoming on local minimum pits in the evolutionary search.

The generic algorithm may use a Crossing over operator, and Bounded Crossing Over. The method can limit the connections of a Neural Network, when the Neural Network is trained using Genetic Algorithm, thereby helping reducing the computation time of the Neural Network.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 schematically illustrates the data flow in a method for object detection, according to the '510 patent.

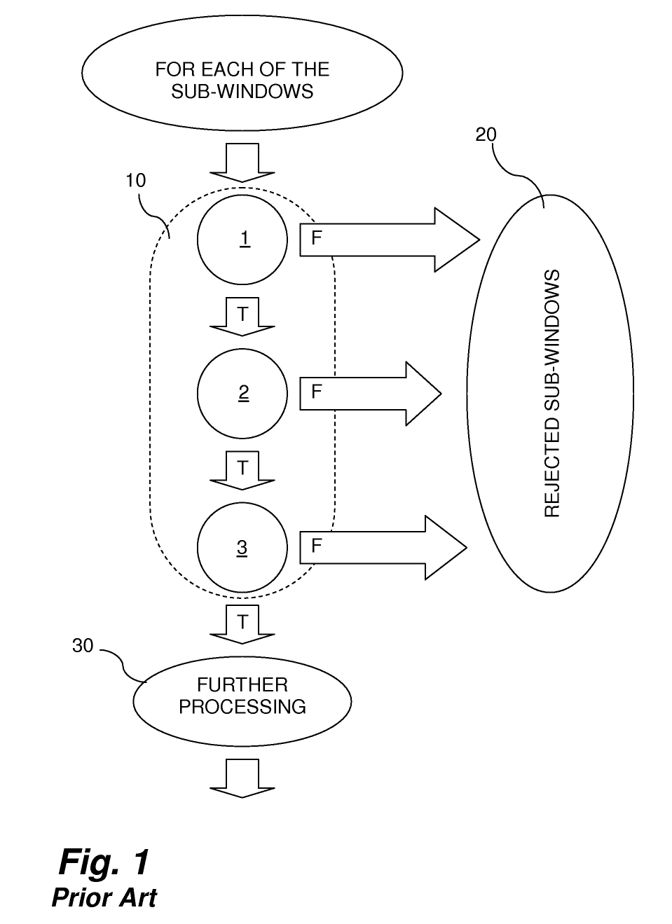

FIG. 2 schematically illustrates the data flow in each of the classifiers of the cascade of FIG. 1.

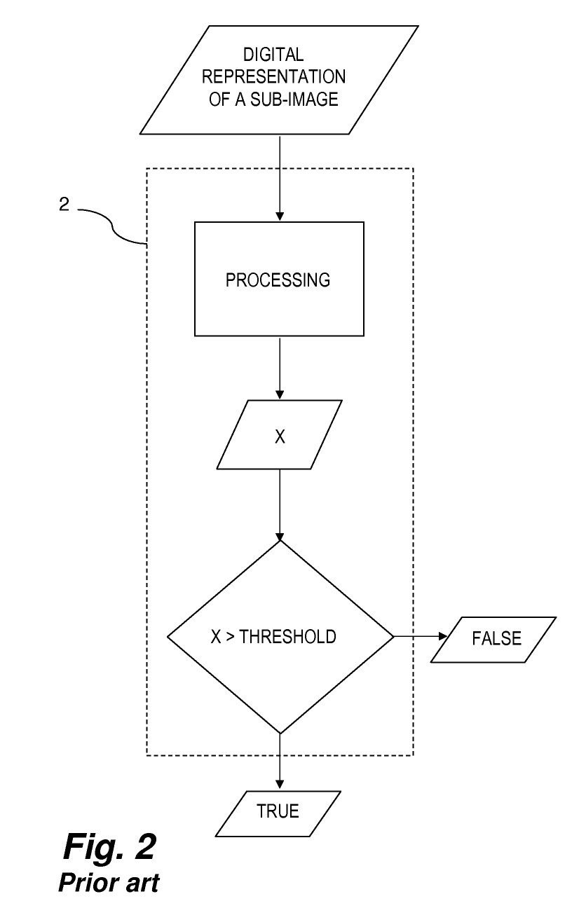

FIG. 3 schematically illustrates the data flow in a method for object detection, according to one embodiment of the invention.

FIG. 4 schematically illustrates the data flow in each of the classifiers of the cascade of FIG. 3.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of brevity.

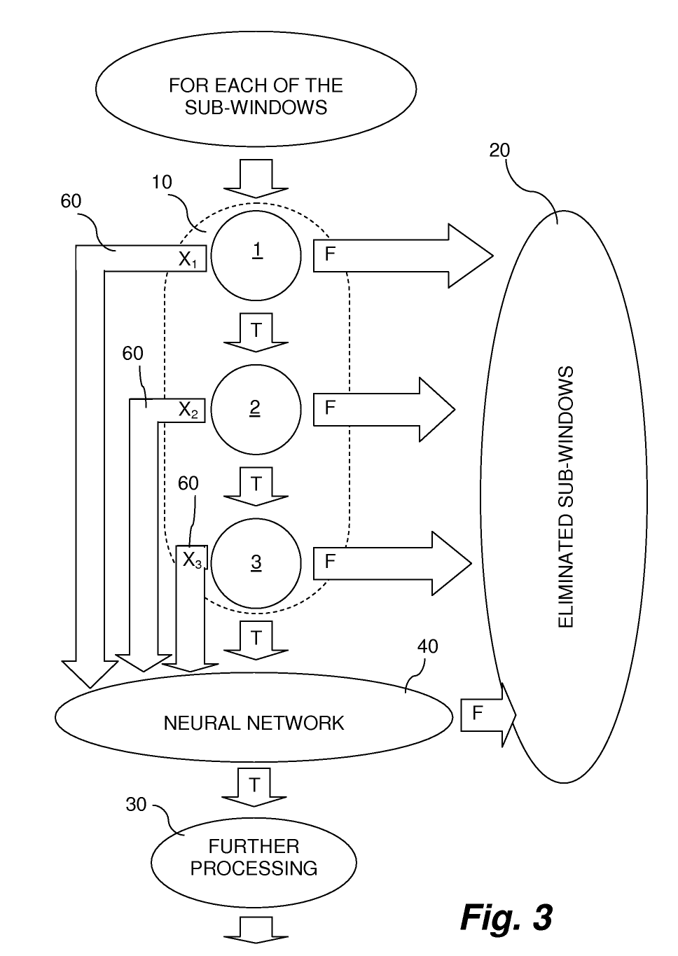

FIG. 3 schematically illustrates the data flow in a method for object detection, according to one embodiment of the invention.

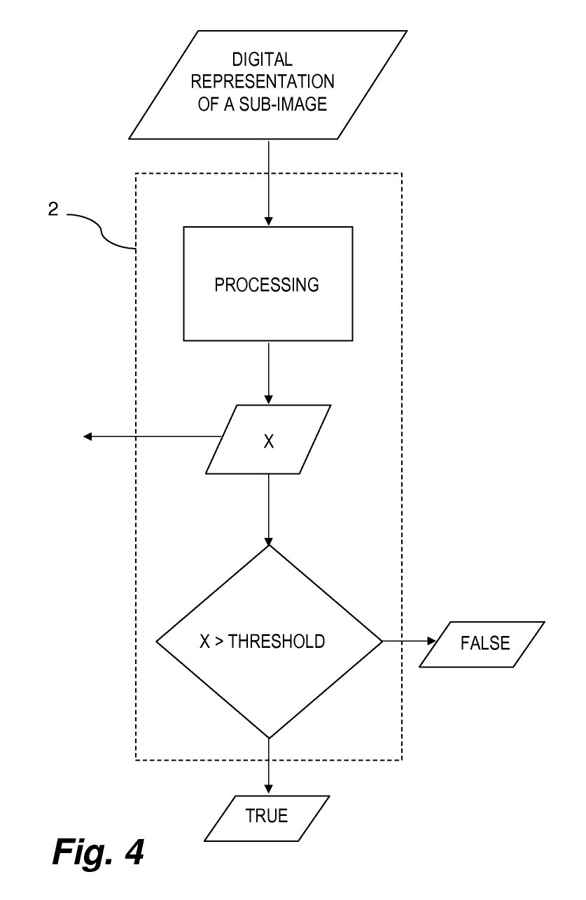

FIG. 4 schematically illustrates the data flow in each of the classifiers of the cascade of FIG. 3.

As mentioned above, in a classifier, a result of the processing is a value, which is referred herein as the Classifier's Real Value (CRV), and marked in the figures by the symbol X.

The difference between the classifier of the '510 patent (as illustrated in FIG. 3) and that of the present invention (as illustrated in FIG. 4) is that according to this embodiment of the invention (FIG. 4), the CRV (value X) is further used for post processing.

Referring to FIG. 3, according to this embodiment of the invention, the CRV vector (X₁, X₂, and X₃) is processed by a post-classifier 40, whose purpose is to determine in a more accurate way whether the tested sub-window, which has passed the tests of all the classifiers of the cascade 10, indeed comprises an image of the object of interest.

The input to the post-classifier 40 is a vector of the CRV values (marked in FIG. 3 by symbols X₁, X₂, and X₃), which has been calculated by the classifiers of cascade 10.

Thus, while in the '510 patent the CRV value X, which is the result of the classifier's processing, is used only for determining the retuned value of the classifier (i.e., TRUE or FALSE), according to embodiments of the present invention the CRV is used for further processing.

A Neural Network is an example of a post-classifier. The Neural Network is referred to herein also as Supportive Neural Network (SNN), as it supports or rejects the determination of the cascade of classifiers.

As illustrated in FIG. 3, the Supportive Neural Network (i.e., the post-classifier) is triggered once the last classifier in the cascade indicates TRUE, which means that the object of interest has been detected by cascade 10 in the processed sub-window.

It should be noted that in patent '510, the CRVs are not used for further processing. Since the CRVs have a relation to the likelihood of the image of a sub-window to comprise a searched object, they provide important information about the likelihood in question. The SNN (i.e., the post-classifier) makes the final decision. It uses all the CRVs of the classifiers of the cascade. The SNN makes a “smarter” decision in that it has a wider perspective, due to processing all the information that can imply on likelihood of an object in the image of a sub window.

In the real world, the probability that all the classifiers of a cascade will return a TRUE value is very “small”, such as, for example, of ˜1:1,000,000. Since the SNN is applied only once (in such case wherein all the classifiers of the cascade have returned a TRUE), under such relations it can employ an intensive processing, and still not affect the overall speed of object detection significantly.

According to embodiments of the present invention, the Supportive Neural Network (i.e., the post classifier) is trained using two sets of sub-windows that contain the object, and sub-windows that do not contain the object. The Supportive Neural Network is trained using supervised learning methods.

Supervised learning is a machine learning technique for learning a function (the SNN in the presented example), from training. The task of the supervised learner is to predict the value of the function for any valid input object after having seen a number of training examples (i.e. pairs of input and target output). To achieve this, the learner has to generalize from the presented data to unseen situations in a “reasonable” way.

As mentioned above, a Neural Network is only an example of a post-classifier, and other evaluating methods can be employed as well. For example, SVM—Support Vector Machines, LDA—Linear Discriminant Analysis, and other classification methods. In any case, according to embodiments of the present invention, “thrown away” data is used as input for a post-classifier only when all the classifiers of the cascade have indicated detection of the object of interest.

### AN EXAMPLE

Assuming a digital image is divided into M sub-windows Si (each one is a 20*20 sub-image in the form of an integral image), and the cascade of classifiers comprises N classifiers Gⱼ.

Vj is a vector Xⱼ=Gⱼ(Sᵢ). Xⱼ is the output of classifier Gⱼ before threshold Tj translates the output to a Boolean value. A True or False value may be determined by threshold Tj.

According to embodiments of the present invention, vector Vⱼ, j=1 to M, is used as input for a Supportive Neural Network. Thus, assuming NN(V) is the Supportive Neural Network, the result thereof is B=NN(V), wherein B is Boolean value, indicating whether the object is in the sub-window or not.

In contrast to the prior art, which makes no use of the results of the classifiers (i.e., the vector Vj), according to embodiments of the present invention, results of the classifiers are used as inputs for SNN.

In order to use a Supportive Neural Network as means for detecting whether a sub-window which has been indicated by the cascade as comprising an instance of an object indeed comprises the object, the Supportive Neural Network has to be trained. The training can be carried out using supervised learning methods such as a Genetic Algorithm, Back Propagation or any other supervised training method known in the art.

The Neural Network can be of the Feed Forward Neural Network type, Fully Connected Neural Network type, or any other type of classifier that can process a vector of values.

The training set for a Supportive Neural Network is a set of vectors wherein each represents the cascade's result to a sub image.

V=(X1, X2 . . . XL)

Wherein V is the input vector for the Supportive Neural Network

Xi=SIGMA j=1 . . . n(Wj*Hj)

$${\sum }_{j = 1}^{N} {w}_{j} {h}_{j} ( x )$$

Wherein Wj is a predefined weight for each threshold function Hj, n is the number of threshold functions in the i-th Classifier on the cascade.

The training set is divided to a set of, for example, 10,000 sub windows that contain the object, and to a set of 10000 windows that do not contain the object.

Similarly, two control sets of 5000 sub windows that contain the object, and two sets of 5000 windows that do not contain the object. The control sets are used to test the generalization of the SNN from the presented data to unseen situations

The SNN is trained using Genetic Algorithms on the two sets in order to classify them. The training is done until reaching the wanted detection rate on the control sets.

### LDA Method

The following describes another method for training the SNN, or can be used to find the best Shattering vector to be approximated by each classifier in the cascade, using a linear combination of features.

First of all cumulative/online proprietary LDA—Linear Discriminator Analysis helps to find the best Shattering vector—the normal to the best shattering plane in each additional classification.

Cumulative or Online LDA—Proprietary Metivity Algorithm

LDA distinguishes between a cluster of sample vectors and other non sample vectors.

Cumulative Orthonarmalization works as follows:

It is divided into two algorithms. One for samples and one for both samples and non-samples.
1) An initial orthonormal canonical basis is assigned to n vectors say

V₁(0), V₂(0), . . . , Vₙ(0) such that

V₁(0)=(1,0,0, . . . ,0),V₂(0)=(0,1,0,0, . . . ,Vₙ(0)=(0,0, . . . ,1)
2) The initial average of the vectors is set to Avg=\vec{0}=(0,0, . . . ,0). Also, the samples counter Counter is set to zero.
3) When a new sample vector q(s+1) is trained then the average is first updated:

$$Avg ( s + 1 ) ← \frac{s * Avg ( s ) + q ( s + 1 )}{s + 1}$$

A new delta vector is calculated. Delta(s+1)=q(s+1)−Avg(s) s.t. q=Input
4) The dot product between the delta vector and V1(s) is calculated. A vector with a squared norm of delta vector SV=Delta(s+1)*|Delta(s+1)| is calculated. If Delta(s+1)*V₁(s)>0 then V₁(s+1)←V₁(s)+SV else V₁(s+1)←V₁(s)−SV.
5) For Vₖ the online update rule is:

$$If Delta ( s + 1 ) * {V}_{k} ( s ) > 0$$

$$then {V}_{k} ( s + 1 ) ← {V}_{k} ( s ) + SV - {\sum }_{j = 1}^{k - 1} ( SV * {V}_{j} ( s + 1 ) \frac{{V}_{j} ( s + 1 )}{\vert {V}_{j} ( s + 1 ) \vert} )$$

$$Else$$

$${V}_{k} ( s + 1 ) ← {V}_{k} ( s ) - SV + {\sum }_{j = 1}^{k - 1} ( SV * {V}_{j} ( s + 1 ) \frac{{V}_{j} ( s + 1 )}{\vert {V}_{j} ( s + 1 ) \vert} )$$

6) A second update that follows (6) is

$${V}_{k} ( s + 1 ) ← {V}_{k} ( s + 1 ) - {\sum }_{j = 1}^{k - 1} ( {V}_{k} ( s + 1 ) * {V}_{j} ( s + 1 ) \frac{{V}_{j} ( s + 1 )}{\vert {V}_{j} ( s + 1 ) \vert} ) .$$

(6) can be skipped but this section (7) is mandatory.
7) The counter is updated Counter←Counter+1. Obviously Counter=s+1.
8) Calculation of a distance Dist to an input vector Input is

$$Dist ( Input , Avg ) = \sqrt{{\sum }_{j = 1}^{n} \frac{{( ( Input - Avg ) * {V}_{j} )}^{2} Count}{{\vert Vj \vert}^{3}}} .$$

Explanation: The vector

$$\frac{{V}_{j}}{\vert {V}_{j} \vert}$$

approximates and eigenvector. The value

$$\frac{\vert {V}_{j} \vert}{Count}$$

approximates the variance along the Vⱼ direction. Steps (3)-(8) are repeated for each new sample. In Cumulative LDA the vectors that belong to the cluster we need to classify following the algorithm described in (3)-(8). Then, an inverse distance is calculated as follows:

$$IDist ( Input , Avg ) = \sqrt{{\sum }_{j = 1}^{n} \frac{{( ( Input - Avg ) * {V}_{j} )}^{2}}{\vert Vj \vert Count}}$$

It should be noted that when the value of |Vⱼ| is below a predefined threshold, other vectors with higher distances than j can be discarded. This alone makes Cumulative LDA far superior to classical LDA.
9) Now follows the second part of the algorithm. An average Avg2 is calculated for all non-samples and positive samples cumulatively very similar to (3) which is only for positive samples. Each positive sample runs through (3)-(8) and both negative (non-samples) and positive ones (samples) continue to the following secondary algorithm.
10) The vectors of the previous algorithm are replaced with other cumulatively orthonormal vectors W₁(r),W₂(r), . . . ,Wₙ(r). Also Avg2 is calculated instead of Avg and r=Count2 instead of s=Count.
   The only difference between the algorithm (3)-(8) and the secondary algorithm is that instead of calculating SV=Delta(s+1)*|Delta(s+1)| we calculate SW(Q−Avg2)|Q−Avg2|(IDist(Input, Avg))̂2. Our new delta is (Q−Avg 2) instead of Delta=(q−Avg).
   It should be noted that only WI is needed and the rest of the W vectors can be discarded. This again makes Cumulative or Online LDA far superior to classical LDA.
11) Again, for Wₖ the update rule

$${W}_{k} ( r + 1 ) ← {W}_{k} ( r ) \pm SW \pm {\sum }_{j = 1}^{k - 1} ( SW * {W}_{j} ( r + 1 ) \frac{{W}_{j} ( r + 1 )}{\vert {W}_{j} ( r + 1 ) \vert} ) .$$

12) Followed by

$${W}_{k} ( r + 1 ) ← {W}_{k} ( r + 1 ) - {\sum }_{j = 1}^{k - 1} ( {W}_{k} ( r + 1 ) * {V}_{j} ( r + 1 ) \frac{{V}_{j} ( r + 1 )}{\vert {V}_{j} ( r + 1 ) \vert} )$$

After “many” iterations W₁ will be the Shattering SVM (Support Vector Machine).

### Training the Neural Network Using Special Genetic Algorithm

Genetic Algorithm is one of the ways to train Neural Networks for recognition. In this part, unique manipulations of Genetic Algorithm are suggested.

A Genetic Algorithm (GA) is a search technique used in computing to find exact or approximate solutions to optimization and search problems. Genetic Algorithms are categorized as global search heuristics. Genetic Algorithms are a particular class of evolutionary algorithms (also known as evolutionary computation) that use techniques inspired by evolutionary biology such as inheritance, mutation, selection, and crossover (also called recombination).

In the present invention, a Genetic Algorithm is used to set the neural network behavior, by looking for the best vector of weights for all neural networks' connections, that classifies the training set best.

Genetic Algorithm has three operators: Crossing-Over, Mutation and Selection.

### Selection.

### Positive Reward,

For someone familiar with this art, classifiers compete with each other on the correct classification of M samples. A leading classifier is chosen; then, the rest of the selected classifiers are chosen according to their success and receive a bonus on correct classifications that the leading classifier fails to classify. Selected classifier 2 gets r>1 points for each such classification that the leading fails. For other successful classification it gets 1 point. Selected classifier 3 gets r² points for samples that the leading classifier fails to classify.

For other successful classifications it gets 1 point.

Selected classifier L gets r^{L} points for each successful classification that the leading network fails to classify and gets 1 point for other successful selections.

### Negative Reward,

A leading classifier is chosen, and then the rest of the selected classifiers are chosen according to their success and receive a debit on wrong classifications that the leading classifier fails to classify. For other successful classifications they receive 1 point for each. Selected classifier 2 gets −r points such that r>1 for each classification that the leading classifier fails to classify and that classifier 2 further fails to classifier. For other successful classifications it gets 1 point. Selected classifier 3 gets −r² points for samples that the leading classifier fails to classify and that classifier 3 also fails to classify. For other successful classifications it gets 1 point.

Selected classifier L gets −r^{L} points for each failed classification that the leading network fails to classify and gets 1 point for each of the other successful selections.

If the population is of N classifier then survival is N/8 with positive reward,

N/8 with negative reward and N/4 with ordinary classical selection plus a bonus on the difference from the leading classifier.

These new selection operators can overcome local minimum pits in the evolutionary search.

### Crossing Over

Two types of crossing over operators are used for training Neural Networks.

There is a count C of different neurons between, say, classifier A and classifier B. Then the algorithm only treats neuron only indices for which neurons are different. It selects C/2 such indices from classifier A and C/2 other indices (from indices on which classifier A and classifier B are different) from classifier B. The remainder, say, D indices for which the neurons are the same in both classifier A and classifier B are taken as they are. In the preferred embodiment of this invention there is a

### Bounded Crossing Over.

Say that for only C indices neurons will have weights other than zero. An array of C indices is prepared arr[0]=0, arr[1]1, arr[C+D]=C+D−1. Then a random permutation is performed on the array e.g. a[0]=C+D−1, a[1]=5, . . . etc. The following is a code excerpt of such an operation in which
member_bool_selection_array1 says whether a neuron from classifier A is selected or not. Member_bool_selection_array2 says whether a neuron from classifier B is selected or not. c_n_half_mask=C.

c_n=C+D. function_init initializes a random generator. function_mix(&c_perm,c_n) creates a permutation of 0,1, . . . ,c_n−1. c_n_half_mask [C/2]. c_n2_half_mask=cn−[C/2]; c_arr1 contain 1 for used neuron and 0 for unused one in classifier A

c_arr2 contains 1 for used neurons and 0 for unused ones in classifier B.

For example, the following vectors describe the used 1 and unused 0 neurons in classifiers A and B, respectively,

10011001

01001110

Then a valid bounded crossing over with C=4 and C+D=8 will be

member_bool_selection_array1: 10010000

member_bool_selection_array2: 01001000

Here is the code for bounded crossing over:

```
int RAND_RANDOM_CLASS::function_combine(int c_arr1[ ],
            int c_arr2[ ],
            int c_zero,
            int c_n,
            int c_n_mask)
{
  int i,j,k,c_n_half_mask,c_n2_half_mask,c_idx;
  int *c_perm;
  if (c_n_mask <= 1 | | c_n <= 1 | | c_n_mask > c_n) return −4;
  if (function_init(c_n)<0) return −1;
  c_perm = NULL;
  if (function_mix(&c_perm,c_n)<0) return −1;
  c_n_half_mask = c_n_mask >> 1;
  c_n2_half_mask = c_n_mask − c_n_half_mask;
  memset(member_bool_selection_array1,0, sizeof(bool)*c_n);
memset(member_bool_selection_array2,0, sizeof(bool)*c_n);
for (i = 0,k=0,j=0;i<c_n && (k+j)<c_n_mask;i++)
{
  c_idx = c_perm[i];
  if (rand( ) & 1)
  {
    if (k<c_n_half_mask)
    {
      if (c_zero != c_arr2[c_idx])
      {
          member_bool_selection_array2[c_idx] = 1;
          k++;
      }
          else if (c_zero != c_arr1[c_idx] && j<c_n2_half_mask)
      {
          member_bool_selection_array1[c_idx] = 1;
      j++;
      }
      }
    }
    else
    {
      if (j <c_n2_half_mask)
      {
        if (c_zero != c_arr1[c_idx])
        {
          member_bool_selection_array1[c_idx] = 1;
          j++;
        }
        else if (c_zero != c_arr2[c_idx] && k < c_n_half_mask)
        {
          member_bool_selection_array2[c_idx] = 1;
          k++;
        }
      }
    }
  }
      // Correctness of the algorithm:
      // In each loop cycle one 1-bit is selected unless
      // c_arr2[c_idx] and c_arr1[c_idx] are zero or
      // k = c_n_half_mask or j = c_n2_half_mask.
      // Without loss of generalization, suppose that at first
      // k = c_n_half_mask. At most c_n_half_mask 1-bits are
      // common to both c_arr1 and C_arr2. So at most c_n_half_mask
      // secltions of 1-bits from c_arr1 are occupied by selections
      // from c_arr2 because both c_arr2 and c_arr1 where 1 in those
      // indices. So at least c_n_mask − c_n_half_mask indices of
      // c_arr1 are available while the loop runs.
      // Thus c_n_half_mask idices are selected from c_arr2 and
      // c_n2_half_mask from c_arr1.
        delete[ ] c_perm;
  return 1;
}
```

The crossing over method can be used on weights instead of neurons. When two classifiers are different in only one neuron, then half of the different weights of that neuron are taken from classifier A and half of the other weights are taken from classifier B.

### Mutation

There are two types of mutations, bounded and unbound.

We will focus on the bounded one and for weights rather than neurons.

First a permutation on indices 0,1, . . . ,C+D−1 is performed; then, only the first C/2 non zero weights (after the permutation is done) are selected and the rest are set to 0.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for object detection of an object of interest in a digital image of an optical processing device comprising:
dividing said digital image into a plurality of sub-windows of substantially the same dimensions;
processing the image of each of said sub-windows by a cascade of homogeneous classifiers, wherein each of said homogenous classifiers produces a CRV, being a value relative to the likelihood of a sub-window to comprise an image of said object of interest, and wherein each of said classifiers having an increasing accuracy in identifying features associated with said object of interest; and
upon classifying by all of the classifiers of said cascade a sub-window as comprising an image of said object of interest, applying a post-classifier on the CRVs of said cascade, for evaluating the likelihood of said sub-window to comprise an image of said object of interest, wherein that said post-classifier differs from said homogenous classifiers.

2. The method according to claim 1 wherein said post-classifier is based on a Neural Network.

3. The method according to claim 1 wherein said post-classier is based on a Support Vector Machines.

4. The method according to claim 1 wherein each of said homogeneous classifiers is based on a Linear Discriminant Analysis, such that the best classification vector is used as the vector to be approximated by a linear combination of features and features vectors used in said cascade of classifiers.

5. The method according to claim 1 further comprising a training process, for training said post-classifier to identify an object of interest.

6. The method according to claim 5 wherein said training process is based on a unique cumulative and online LDA method, which updates itself after each new training vector.

7. The method according to claim 1 wherein said training process of the high level classifier method is a unique Genetic Algorithm.

8. The method according to claim 1 wherein said training method is of the Back Propagation type.

9. The method of claim 1 wherein said object of interest is the human face.

10. The method of claim 5 wherein said training process is a Genetic Algorithm.

11. The method according to claim 10 wherein said Genetic Algorithm uses “Selection” operators selected from a group comprising: Positive reward and Negative reward.

12. The method according to claim 10 wherein said Genetic Algorithm is a selected one of Crossing Over Operator and Bounded Crossing Over.
